(19) United States
(12) Patent Application Publication
(10) Pub. No.: US 2006/0016306 A1
(43) Pub. Date: Jan. 26, 2006

(54) Landscape utility knife assembly

(76) Inventor: Clemente Conde, Waco, TX (US)

Correspondence Address: Richard D. Egan;O'KEEFE, EGAN & PETERMAN, Building C, Suite 200, 1101 Capital of Texas Highway South, Austin, TX, 78746, US

(21) Appl. No.: 10/897,761

(22) Filed: Jul. 23, 2004

(51) Int. Cl. B26B 29/00

(52) U.S. Cl. 83/13; 30/294

(57) ABSTRACT

A landscape utility knife assembly discloses a single tool that can puncture the middle of a landscape liner and make the incisions necessary to place plants in the middle region of a landscape or garden area. The knife assembly consists of a replaceable blade and housing. The housing is composed of three regions: a handle region, a blade region, and a penetration region. These regions, which compose the housing, are arranged geometrically to form an acute angle. The tip of the penetration region forms a sharp point that can puncture a landscape liner. The penetration region is adjacent to the blade region and serves also to guide the liner into the replaceable blade that is exposed and recessed at the vertex of the angle formed by the housing.

### TECHNICAL FIELD OF THE INVENTION

This invention relates in general to the field of utility knives and, more particularly, to those utility knives for cutting landscape liners.

### BACKGROUND OF THE INVENTION

It is often desirable in landscapes and gardens to prevent weeds from commingling with other plants and the erosion of soil due to weather. In order to prevent such undesirable results, it is helpful to lay a protective liner in the form of a tarp or fabric on the surface of the soil. To provide adequate coverage of the soil and not detract from the aesthetic design created by the landscaper, the liner is often cut to match the geometric shape of the garden or landscape area. The prior art landscape utility knife in FIG. 1 proves to be effective for cutting the outer boundary of the design because an edge exists from which the prior art knife can begin the cut into the liner. The prior art knife consists of a blade exposed and recessed in a housing shaped to resemble the head of a duck. An area protruding adjacent to the blade serves to guide the liner into the blade as the tool cuts and is dull and rounded to prevent the tip from puncturing the liner. More particularly, FIG. 1 is a left side perspective view of the prior art in cutting tools for landscape liners. Edge 7 is used to guide the liner into cutting blade 6 when the prior art device is pulled toward the user. Point 8 of the prior art is dull and rounded to prevent the tip from puncturing the landscaping liner.

For purposes of ease and efficiency, the landscape liner is often laid before any plants are placed into the landscape or garden area. In order to place plants into the landscape or garden area after the landscape liner is laid, the landscaper must make incisions in the middle region of the liner or tarp to permit the plants to contact the soil. Because this middle region of the liner does not present an edge from which to begin the cut, the prior art is unable to make the necessary incisions in the middle region of the liner. Rather, to utilize the prior art, a separate tool is needed to first puncture the middle region of the liner, thereby creating an edge in the liner from which a cut may begin. For purposes of ease and efficiency, it is desirable to have a single tool that can both puncture the liner, thereby creating an edge, and cut the incision in the middle region of the landscape liner.

### SUMMARY OF THE INVENTION

In accordance with the present invention, a landscape knife assembly is disclosed that provides advantages over conventional landscape liner cutting tools.

One embodiment of this invention is a knife assembly consisting of a replaceable blade and a housing. The housing is composed of three regions: a handle region, a blade region, and a penetration region. Together, these regions form an acute angle whereby the blade region is flanked on opposite sides by the handle and penetration region. The housing could be decoratively designed to resemble an animal or character. For example, the handle, blade, and penetration regions could be fashioned to resemble a bird.

The handle extends from the blade region for a length that permits the knife assembly to be used comfortably with one hand. The handle could be designed to ergonomically match the user's hand by creating a plurality of indentions on the inside edge of the handle. Further, the handle region could contain a means to aid in holding the knife assembly, for example, knurling or rubber grips. The end of the handle opposite the blade region could contain a small hollowed region extending from the surface of one side of the handle to the opposite side. This hollowed region could be used to attach the knife assembly to some other device, such a tool belt or workbench, to facilitate the transporting and storing the knife assembly.

The blade region contains a replaceable blade accessible from one side of the blade region by a removable covering. The removable covering is held in place by a fastening mechanism such as a screw. The blade region exposes the cutting edge of the replaceable blade permitting the landscaping liner to be cut by the replaceable blade. The edge of the blade region adjacent to the exposed area of the replaceable blade is shaped to guide the landscape liner toward the cutting edge of the exposed replaceable blade.

The penetration region extends from the blade region opposite the handle region. The end of the penetration region opposite the blade region forms a sharp point sufficient to puncture a landscape liner. The edge of the penetration region is adjacent to the exposed area of the replaceable blade and shaped to guide the landscape liner toward the cutting edge of the exposed replaceable blade.

A technical advantage of the present invention is that with a single hand and a single tool, a landscaper can puncture the middle of a landscape liner and make the cuts necessary to place plants in the middle region of a landscape or garden area. The same knife assembly can be used to puncture the liner, thereby creating an edge, and cut the incision in the middle region of the landscape liner.

### BRIEF DESCRIPTION OF THE DRAWINGS

A more complete understanding of the present invention and advantages thereof may be acquired by referring to the following description taken in conjunction with the accompanying drawings, in which like references numbers indicate like features. It is to be noted, however, that the accompanying drawings illustrate only exemplary embodiments of the invention and are therefore not to be considered limiting of its scope, for the invention may admit to other equally effective embodiments.

FIG. 1 is a left side perspective view of the prior art in cutting tools for landscape liners.

FIG. 2 is a left side perspective view of one embodiment of the landscape knife assembly in accordance with the present invention.

FIGS. 3A-3C are exemplary cross-sections of portions of the landscape knife assembly in accordance with the present invention.

FIG. 4 is a right side perspective view of one embodiment of the landscape knife assembly in accordance with the present invention demonstrating the ability to effectively puncture a landscape liner and begin cutting from the middle region of the liner.

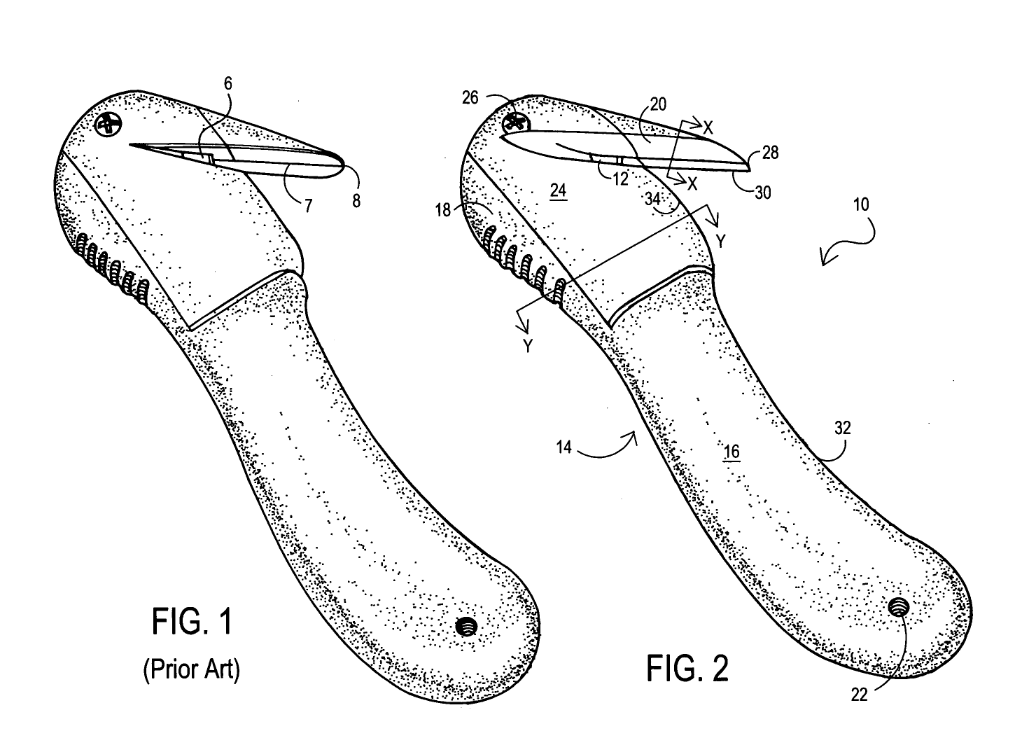

### DETAILED DESCRIPTION OF THE INVENTION

FIG. 2 is a left side perspective view of one embodiment of the landscape utility knife assembly, indicated generally at 10, in accordance with the present invention. Knife assembly 10 could be decoratively designed to resemble an animal or character. For example, blade region 18 and penetrating region 20 could be made to resemble a bird's head and beak, respectively. Knife assembly 10 consists of a housing indicated generally at 14. Housing 14 is comprised of a handle region 16, a blade region 18, and a penetration region 20. A replaceable blade 12 may be located at blade region 20. Together, regions 16, 18, and 20 form an acute angle.

The handle region 16 extends from the blade region for a length that permits the knife assembly to be used comfortably with one hand. Handle region 16 could be designed to ergonomically match the user's hand by creating a plurality of indentions on edge 32. Further, the surface of handle region 16 could contain a means to aid in holding the knife assembly, for example, knurling or rubber grips. At the end of handle region 16 opposite of blade region 18, a small hollowed region 22 extends from one side of the handle to the other. Hollowed region 22 could be used to attach knife assembly 10 to some other device thereby facilitating transportation and/or storage.

Blade region 18 contains replaceable blade 12 accessible by removable covering 24 on one side of the blade region. Replaceable blade 12 is exposed and recessed at the vertex of the angle formed by the housing 14. Removable covering 24 is attached to housing 14 by a fastening mechanism commonly used in the art of utility knives such as screw 26. As is known in the art, removal of the screw 26 allows for a portion of housing 14 to provide access for removing and/or inserting a blade. The replaceable blade 12 may be a standard utility knife blade commercially available at hardware stores and the like. Blade region 18 exposes the cutting edge of replaceable blade 12 permitting the landscape liner to be cut by replaceable blade 12. Edge 34 of blade region 18 is shaped to guide the landscape liner toward the cutting edge of the exposed replaceable blade 12. Though described herein as a replaceable blade, it will be recognized that blade 12 need not be replaceable but rather may be permanent.

Penetrating region 20 is adjacent to blade region 18. The end of penetrating region 20 forms a sharp point 28 that can be used to puncture a landscaping liner. Point 28 is configured to be sufficiently sharp to penetrate a landscape liner. Edge 30 of the penetrating region forms an acute angle with the other regions of housing 14 to guide the liner into the cutting edge of replaceable blade 12 as knife assembly 10 is pulled toward the user.

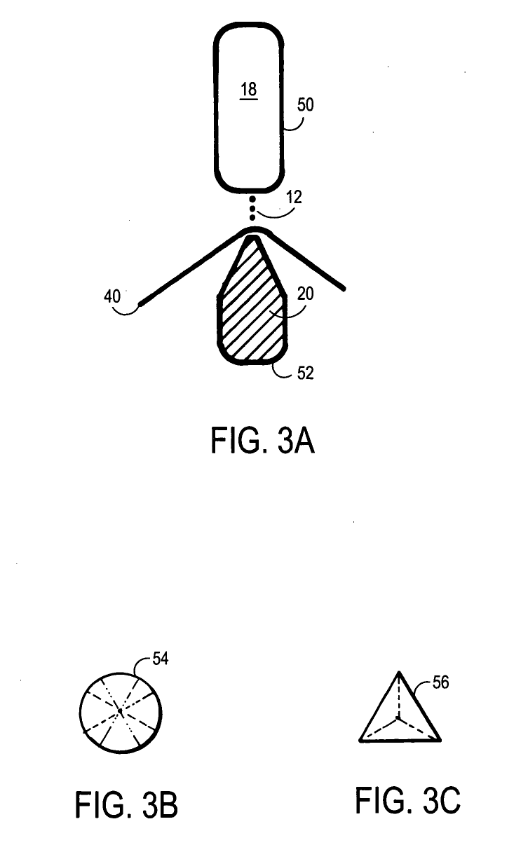

FIG. 3A illustrates exemplary cross-sections of portions of the landscape utility knife assembly 10 of FIG. 2. More particularly, FIG. 3A illustrates an exemplary cross-section 52 of penetration region 20 along cross-section line X-X of FIG. 2. In addition, FIG. 3A illustrates an exemplary cross-section 50 of blade region 18 along cross-section line Y-Y of FIG. 2. FIG. 3A further illustrates a view looking into the replaceable blade 12 and also illustrates a landscape liner 40 located between the penetration region 20 and the blade region 18. FIGS. 3B and 3C are additional exemplary cross-sections of penetration region 20 along cross-section line X-X of FIG. 2. The cross section of penetration region 20 may represent a variety of shapes, including circle 54 as shown in FIG. 3B or triangle 56 as shown in FIG. 3C or other shapes. Regardless of the shape of the cross-section of penetrating region 20, the end of penetrating region 20 desirable forms a sharp point 28 sufficient to puncture a landscape liner.

Housing 14 could be constructed from a number of materials suitable for landscape utility knives, including metal or plastic. In the embodiment of FIG. 2, knife assembly 10 is constructed of injection molded plastic. The housing 14 may be formed of one material such that all regions (the handle, blade and penetration regions) are formed of the same material. Alternatively, different regions may be formed of different materials. In addition, portions (or all) of the housing may be hollow. In one embodiment the blade region may be hollow, however, the other regions may be solid or hollow.

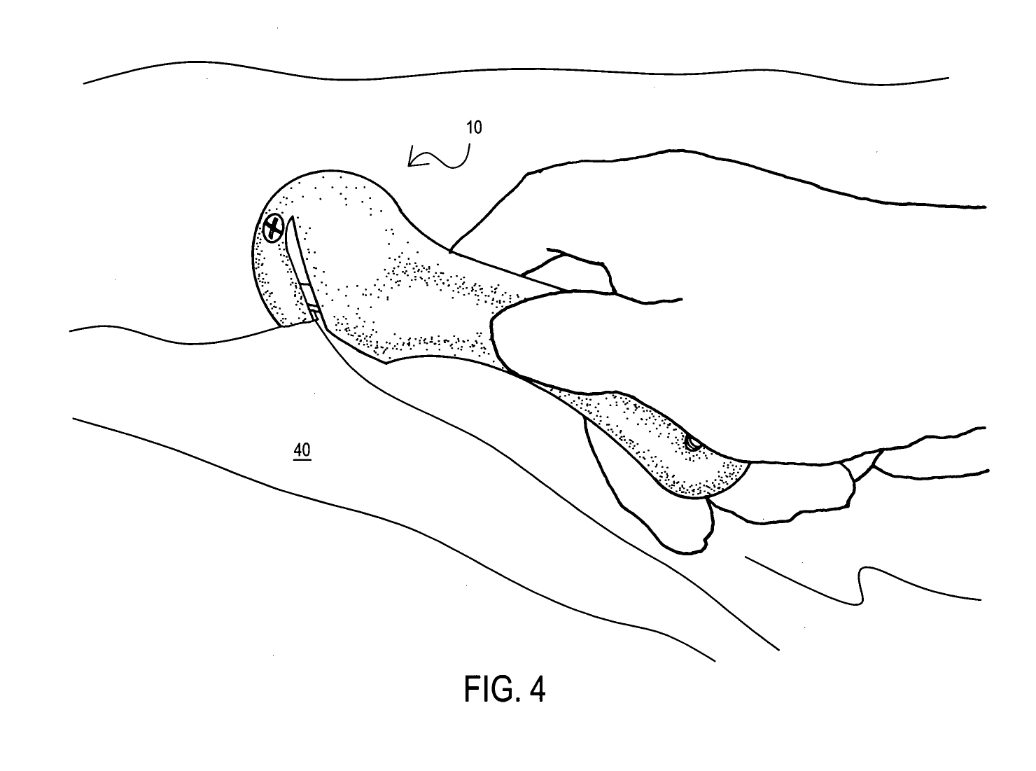

FIG. 4 is a right side perspective view of one embodiment of the landscape knife assembly 10 in accordance with the present invention demonstrating the ability to effectively puncture a landscape liner 40 and begin cutting from the middle region of the liner. A technical advantage of the present invention is that with a single hand and a single tool, a landscaper can quickly and smoothly puncture the middle of a landscape liner and make the cuts necessary to place plants in the middle region of a landscape or garden area. The same knife assembly can be used to puncture the liner, thereby creating an edge, and cut the incision in the middle region of the landscape liner.

Further modifications and alternative embodiments of this invention will be apparent to those skilled in the art in view of this description. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the shape, size, and arrangement of parts. For example, equivalent elements or materials may be substituted for those illustrated and described herein, and certain features of the invention may be utilized independently of the use of other features, all as would be apparent to one skilled in the art after having the benefit of this description of the invention.

What is claimed is:

1. A method of cutting landscape liners, which comprises:
providing a landscape utility knife having a cutting blade and a housing, the housing configured to have a penetration point; and
penetrating a landscape liner with the penetration point of the landscape utility knife; and
cutting a slit adjacent to the puncture in the landscape liner with the cutting blade of the landscape utility knife.

2. A method of cutting landscape liners, as recited in claim 1, wherein the landscape utility knife has a replaceable blade.

3. A method of cutting landscape liners, as recited in claim 1, wherein the landscape utility knife has a handle region, a blade region, and a penetration region, wherein together the handle region, the blade region, and the penetration region form an acute angle.

4. A method of cutting landscape liners, as recited in claim 3, wherein the landscape utility knife has a replaceable blade.

5. A method of cutting landscape liners, as recited in claim 4, wherein the penetration region extends from the blade region, the penetration region having a point at a tip of the penetration region to form the penetration point, the tip being sufficiently sharp to penetrate the landscape liner.

6. A method of cutting landscape liners, as recited in claim 1, wherein the landscape utility knife has a penetration region extending from a blade region, the penetration region having a point at a tip of the penetration region to form the penetration point, the tip being sufficiently sharp to penetrate the landscape liner.

7. A method of cutting landscape liners, as recited in claim 1, wherein the landscape utility knife has a handle region that is ergonomically designed.

8. A method of cutting landscape liners, as recited in claim 1, wherein the landscape utility knife has a removable covering on one side of a blade region, the removable covering attached to the landscape utility knife housing by a fastening mechanism.

9. A landscape utility knife for cutting landscape liners, which comprises:
a blade;
a landscape utility knife housing;
a handle region formed as part of the landscape utility knife housing;
a blade region formed as part of the landscape utility knife housing;
a penetration region extending from the blade region and forming a point at a penetration region tip sufficiently sharp to penetrate a landscape liner;
wherein the handle region, the blade region, and the penetration region form an acute angle.

10. The landscape utility knife of claim 9, wherein one side of the blade region contains a removable covering attached to the landscape utility knife housing with a fastening mechanism that secures the blade in the landscape utility knife housing.

11. The landscape utility knife of claim 10, wherein the blade is replaceable.

12. The landscape utility knife of claim 9, wherein the blade is replaceable.

13. The landscape utility knife of claim 9, wherein the handle region is ergonomically designed.

14. The landscape utility knife of claim 9, wherein the handle region contains a hollowed region on the end opposite the blade region.

15. The landscape utility knife of claim 9, wherein the landscape utility knife housing is shaped to resemble a head of a bird.

16. A utility knife for cutting materials, which comprises:
a replaceable blade;
a utility knife housing;
a handle region formed as part of the utility knife housing;
a blade region formed as part of the utility knife housing; and
a penetration region extending from the blade region and forming a point at a penetration region tip sufficiently sharp to penetrate a material,
wherein the handle region, the blade region, and the penetration region form an acute angle, and
wherein one side of the blade region contains a removable covering attached to the utility knife housing by a fastening mechanism.

17. The utility knife of claim 16, wherein the handle is ergonomically designed.

18. The utility knife of claim 16, wherein the handle contains a hollowed region on the end opposite the blade region.

19. The utility knife of claim 16, wherein the utility knife housing is shaped to resemble a head of a bird.
